(19) United States
(12) Patent Application Publication
(10) Pub. No.: US 2026/0296282 A1
(43) Pub. Date: Oct. 1, 2026

(54) Vehicle Door Pull Handle

(71) Applicants: SHIGERU CO., LTD., Ota-shi (JP); SUBARU CORPORATION, Tokyo (JP)

(72) Inventors: Shinjiro Ogawa, Ota-shi (JP); Kazuya Isogai, Tokyo (JP)

(21) Appl. No.: 19/096,980

(22) Filed: Apr. 1, 2025

(51) Int. Cl. B60N 2/75

(52) U.S. Cl. CPC B60N 2/783

(57) ABSTRACT

A pull handle is mounted on a door trim disposed in a door panel of a vehicle on a vehicle interior side. The pull handle includes a bottom wall portion and a raised wall portion raised from at least an edge portion of the bottom wall portion on the vehicle interior side. An occupant can put his/her fingers on the raised wall portion. A mounting seat portion for securing the pull handle to the door panel is formed in the bottom wall portion such that the mounting seat portion is protruded downward. A thinned-out part continuous from the mounting seat portion to the edge portion of the bottom wall portion is formed in the bottom wall portion. The thinned-out part includes a thinned-out portion extending along a vehicle length direction and a thinned-out portion extending along a vehicle width direction.

### BACKGROUND

The present disclosure relates to a pull handle disposed on a door of a vehicle on a vehicle interior side thereof.

A door of a vehicle includes a door trim on a door panel on a vehicle interior side thereof. The door trim has a pull handle for an occupant to put his/her fingers thereon for opening and closing the door disposed thereon.

The pull handle disclosed in Unexamined Japanese Patent Application Publication No. H09-109760 includes a raised wall portion for an occupant to put his/her fingers thereon and a bottom wall portion. The bottom wall portion is disposed in a lower end portion of the raised wall portion so that the pull handle can be used as a storage box. The bottom wall portion has a mounting seat portion protruded downward formed therein. The mounting seat portion is used for securing the pull handle to the door panel or a door trim.

### SUMMARY

One embodiment of the present disclosure provides a pull handle for a door of a vehicle. The pull handle is mounted on a door trim disposed in a door panel of the vehicle on a vehicle interior side. The pull handle includes a bottom wall portion and a raised wall portion raised from at least an edge portion of the bottom wall portion on the vehicle interior side. The raised wall portion is configured to allow an occupant to put his/her fingers thereon.

A mounting seat portion for securing the pull handle to the door panel or the door trim is formed in the bottom wall portion such that the mounting seat portion is protruded downward. A thinned-out part continuous from the mounting seat portion to the edge portion of the bottom wall portion is formed in the bottom wall portion.

### BRIEF DESCRIPTION OF THE DRAWINGS

The accompanying drawings are included to provide a further understanding of the disclosure and are incorporated in and constitute a part of this specification. The drawings illustrate example embodiments and, together with the specification, serve to explain the principles of the disclosure.

FIG. 1A is a plan view of a door of a vehicle having a pull handle according to one embodiment of the present disclosure disposed thereon.

FIG. 1B is a perspective view of the pull handle disposed on an armrest, showing the pull handle in a state separated from the door of the vehicle.

FIG. 2 is an enlarged cross-sectional view taken along line II-II of FIG. 1A.

FIG. 3 is a perspective view of the pull handle and the armrest of FIG. 1B, shown in disassembled state.

FIG. 4A is a perspective view of the pull handle in which a grip member and a pull handle core material are assembled together, viewed from a vehicle interior side.

FIG. 4B is a perspective view of the grip member, viewed from the vehicle interior side.

FIG. 4C is a perspective view of the pull handle core material, viewed from the vehicle interior side.

FIG. 5A is a cross-sectional view taken along line 5A-5A of FIG. 4A.

FIG. 5B is a cross-sectional view taken along line 5B-5B of FIG. 4A.

FIG. 6A is a plan view of the pull handle core material.

FIG. 6B is a perspective view of the pull handle core material, viewed from below.

FIG. 6C is a perspective view of the pull handle core material, turned upside down.

FIG. 7 is a perspective view of a pull handle according to a second embodiment of the present disclosure, showing a grip member and a pull handle core material in a disassembled state.

### DETAILED DESCRIPTION

In the pull handle disclosed in the Unexamined Japanese Patent Application Publication No. H09-109760, the bottom wall portion has a wall surface thereof oriented in a vertical direction. Therefore, the bottom wall portion is not easily squashed under a load in a vehicle width direction when a side collision occurs. The mounting seat portion makes the bottom wall portion less easily squashed. These features may adversely affect impact absorbing capability of the pull handle disclosed in the Unexamined Japanese Patent Application Publication No. H09-109760 at a time of side collision. Therefore, it is desired to provide a pull handle for a door of a vehicle that solves the problems mentioned above.

In the following, an embodiment of the disclosure is described in detail with reference to the accompanying drawings. Note that the following description is directed to an illustrative example of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiment which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same numerals to avoid any redundant description.

### First Embodiment

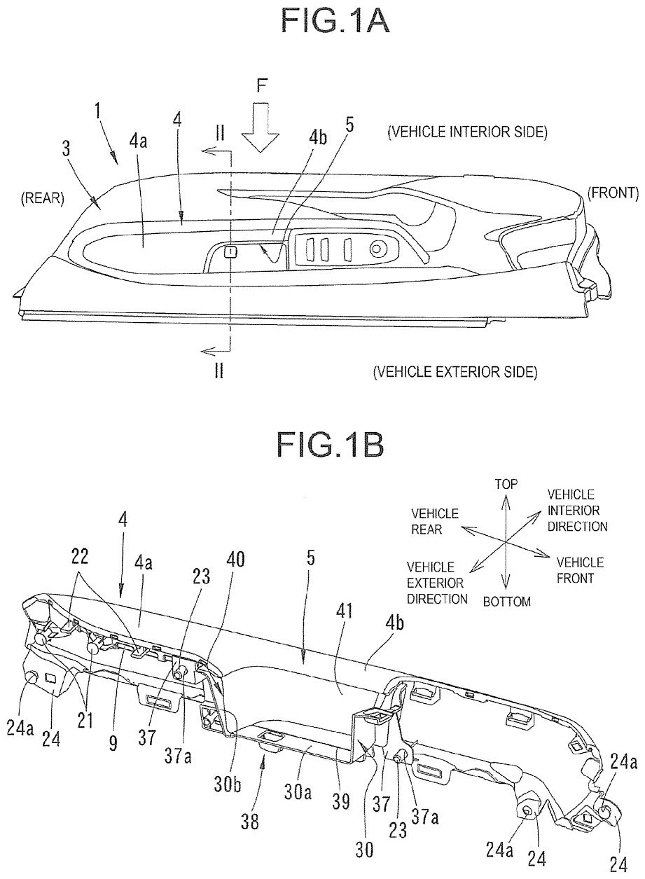

A pull handle for a door of a vehicle according to a first embodiment of the present disclosure will be described hereinafter with reference to FIGS. 1A to 6C. To help understanding of the drawings, a front-rear direction of the vehicle is indicated in FIGS. 1A, 1B, 3, 4A, 4B, 4C, 6A, 6B, 6C and 7 and a vehicle interior side and a vehicle exterior side in a vehicle width direction are indicated in FIGS. 1A, 1B, 2, 3, 5A, 5B, 6A and 7.

### <Door of a Vehicle>

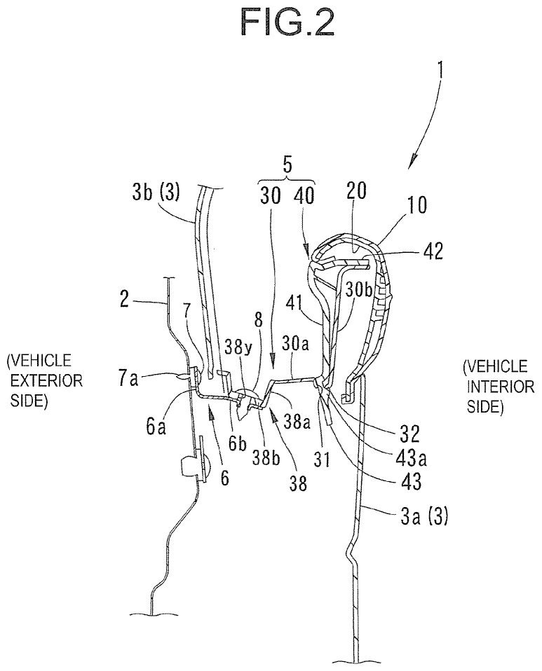

As shown in FIG. 1A, a door 1 of a vehicle includes a door panel 2 made of metal (refer to FIG. 2) and a door trim 3. The door trim 3 is an interior material made of a synthetic resin and is disposed on a vehicle interior side of the door panel 2. The door trim 3 includes an upper trim, a middle trim and a lower trim as major component parts. An armrest 4 is disposed on a vehicle interior side of the door trim 3.

### <The Armrest>

As shown in FIGS. 1A and 1B, the armrest 4 extends in the front-rear direction of the vehicle (vehicle length direction). The armrest 4 includes a wider portion 4a in a rear portion thereof and a narrower portion 4b in a front portion thereof. A pull handle 5 is mounted on the armrest 4, in a front portion of the wider portion 4a and on a vehicle exterior side of the narrower portion 4b. An occupant can rest his/her arm on the wider portion 4a and can put his/her fingers on the pull handle 5 for opening and closing the door 1.

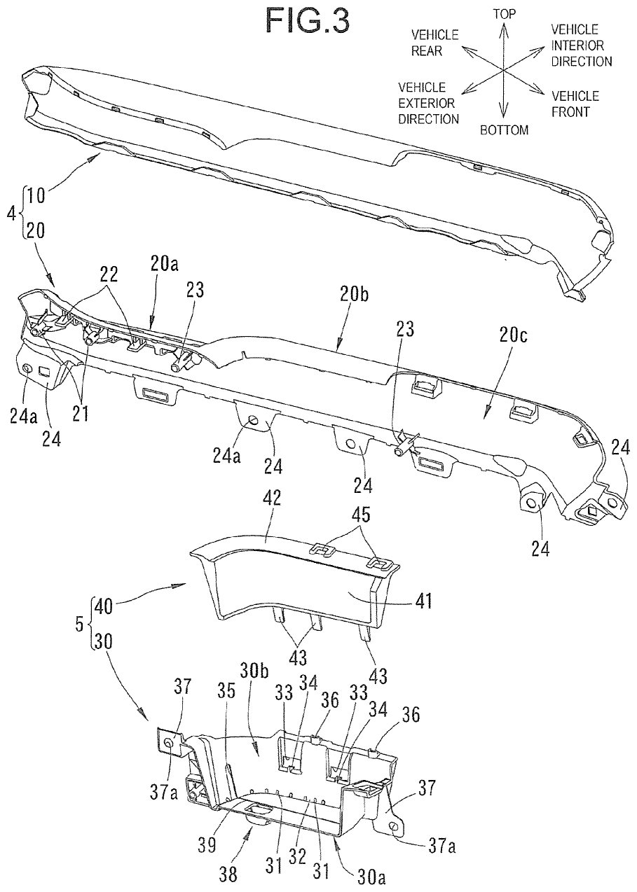

As shown in FIG. 3, the armrest 4 includes a surface skin material 10 and an armrest core material 20 covered with the surface skin material 10. The armrest core material 20 is made of a synthetic resin such as polypropylene. The armrest core material 20 includes a wider portion 20a in a rear portion thereof, a narrower portion 20b in front of the wider portion 20a and a side wall portion 20c. The side wall portion 20c is disposed in lower portions of side portions of the wider portion 20a and the narrower portion 20b on the vehicle interior side. The side wall portion 20c extends beyond the narrower portion 20b in the vehicle length direction. The armrest core material 20 is covered with the surface skin material 10 with a cushion material 9 (shown in FIG. 1B only) disposed on the wider portion 20a.

A plurality of (two in this embodiment) boss portions 21 are disposed in an edge portion of the wider portion 20a of the armrest core material 20 on the vehicle exterior side. The boss portions 21 are disposed spacedly in the vehicle length direction (longitudinal direction of the armrest core material 20). The boss portion 21 has a circular cylindrical configuration and is protruded toward the vehicle exterior side in the vehicle width direction.

A plurality of (two in this embodiment) fitting protrusions 22 are disposed in the edge portion of the wider portion 20a on the vehicle exterior side. The fitting protrusions 22 are disposed spacedly in the vehicle length direction. The fitting protrusions 22 are disposed separated from the boss portions 21. The fitting protrusion 22 has a horizontal plate configuration and is protruded toward the vehicle exterior side in the vehicle width direction.

A plurality of (two in this embodiment) boss portions 23 are disposed respectively in a front side of the edge portion of the wider portion 20a on the vehicle exterior side and in a lower portion of the side wall portion 20c at a front end of the narrower portion 20b. The boss portions 23 are disposed spacedly in the vehicle length direction. The boss portion 23 has a circular cylindrical configuration and is protruded toward the vehicle exterior side in the vehicle width direction.

A plurality of (five in this embodiment) fixation plate portions 24 are disposed in a lower edge portion and a front edge portion of the side wall portion 20c. The fixation plate portions 24 are disposed spacedly in the vehicle length direction. The fixation plate portion 24 has a plate surface thereof oriented in the vehicle width direction. A fitting hole 24a is formed in the fixation plate portion 24.

### <Coupling of the Armrest to the Door Trim>

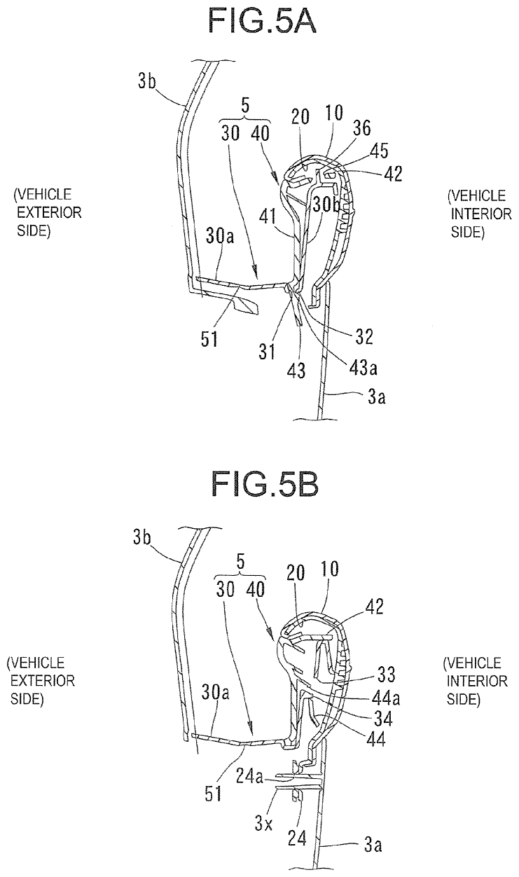

As shown in FIG. 5B, the armrest core material 20 is coupled to the lower trim 3a and to the middle trim 3b of the door trim 3.

The lower trim 3a includes a wall that is generally vertically raised. Five (only one is shown in FIG. 5B) boss portions 3x having a circular cylindrical configuration are disposed in the lower trim 3a. The boss portions 3x are provided corresponding to the fixation plate portions 24. The boss portions 3x are protruded toward the vehicle exterior side in the vehicle width direction. The boss portions 3x are respectively fitted in the fitting holes 24a of the fixation plate portions 24 and distal end portions of the boss portions 3x are respectively welded to peripheral edge portions of the fitting holes 24a.

Two fitting holes (not shown) corresponding to the boss portions 21 (FIG. 3) are formed in the middle trim 3b. The boss portions 21 are respectively fitted in the fitting holes and distal end portions of the boss portions 21 are respectively welded to peripheral edge portions of the fitting holes.

Two fitting recesses (not shown) corresponding to the fitting protrusions 22 (FIG. 3) are also formed in the middle trim 3b. The fitting protrusions 22 are respectively fitted in the fitting recesses.

### <The Pull Handle>

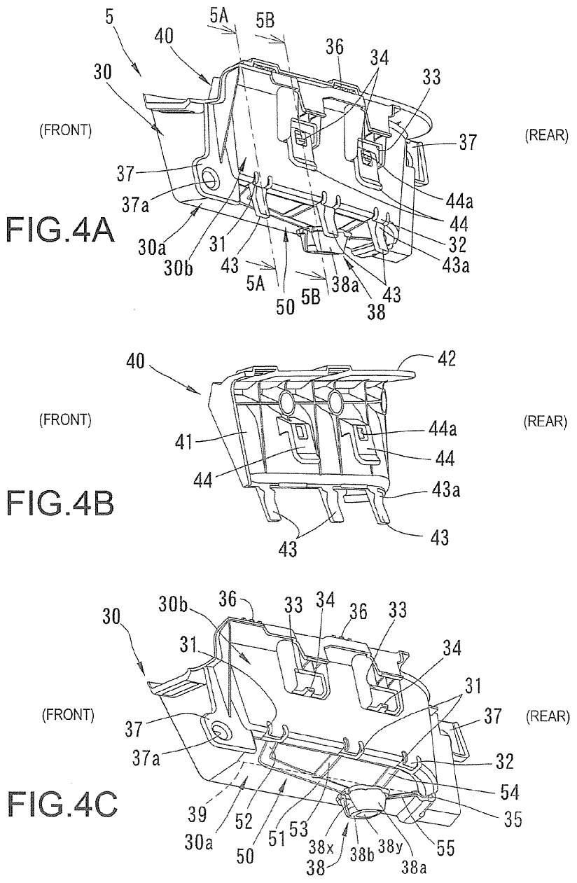

As shown in FIGS. 3, 4A, 4B and 4C, the pull handle 5 includes a pull handle core material 30 (first member) and a grip member 40 (second member).

### <The Pull Handle Core Material>

The pull handle core material 30 is made of a synthetic resin material. The pull handle core material 30 may be made of a material having high rigidity such as filler-added polypropylene (PPF). The pull handle core material 30 includes a bottom wall portion 30a and a support wall portion 30b.

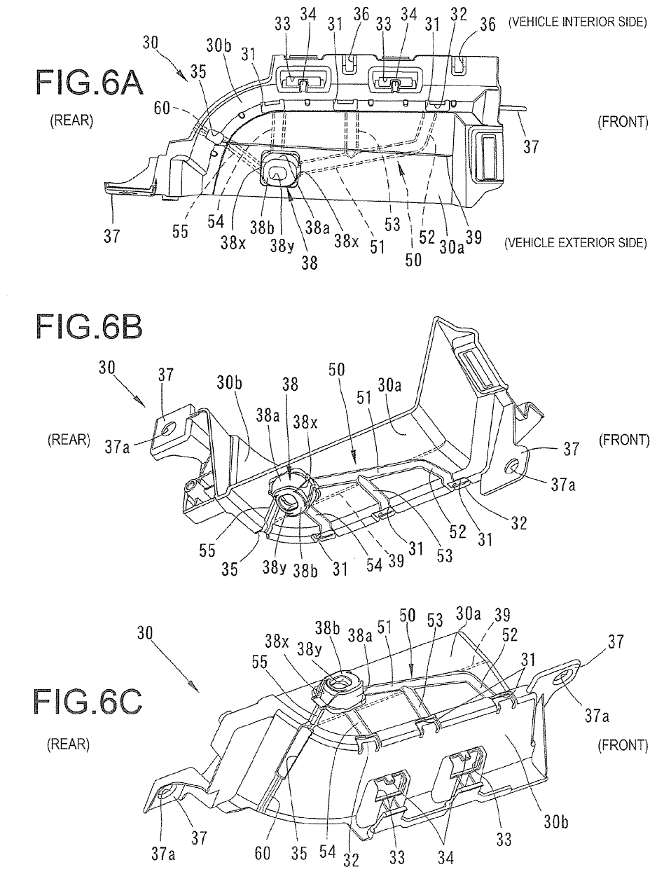

In order for the pull handle 5 to be used as a storage box, the bottom wall portion 30a serves as a bottom of the storage box. In the plan view shown in FIG. 6A, the bottom wall portion 30a has a trapezoidal configuration, gently curved from a vehicle rear side to the vehicle interior side. The support wall portion 30b is raised from a portion of an edge portion of the bottom wall portion 30a other than the vehicle exterior side of the edge portion.

As shown in FIGS. 6A and 4C, a plurality of (three in this embodiment) engagement holes 31 (insertion holes) are formed in an intersecting portion between the bottom wall portion 30a and the support wall portion 30b on the vehicle interior side. The engagement holes 31 are spaced from each other in the vehicle length direction. A claw receiving plate portion 32 is disposed in an edge portion of the engagement hole 31. In this embodiment, the claw receiving plate portion 32 is disposed on the vehicle interior side.

Further, as shown in FIG. 3, a plurality of (two in this embodiment) engagement holes 33 are formed in the support wall portion 30b as well. The engagement holes 33 are spaced from each other in the vehicle length direction. The engagement holes 33 pass through the support wall portion 30b in the vehicle width direction and the vertical direction. A claw portion 34 is disposed in an edge portion of the engagement hole 33. In this embodiment, the claw portion 34 is disposed on an under side of the engagement hole 33 and is protruded toward the vehicle interior side. Further, a lightening hole 35 having an elongated configuration extending from the intersecting portion between the bottom wall portion 30a and the support wall portion 30b to the support wall portion 30b is formed on the vehicle rear side.

As shown in FIG. 3, a plurality of (two in this embodiment) positioning protrusions 36 are disposed in an upper end portion of the support wall portion 30b on the vehicle interior side. The positioning protrusions 36 are spaced from each other in the vehicle length direction. In plan view (FIG. 6A), the positioning protrusions 36 and the engagement holes 33 are alternately arranged in the vehicle length direction. The positioning protrusion 36 has a C-shaped configuration in plan view and is protruded upward.

The support wall portion 30b has fixation plate portions 37, 37 respectively disposed on a vehicle front side and the vehicle rear side thereof. The fixation plate portion 37 has a plate surface thereof oriented in the vehicle width direction. A fitting hole 37a is formed in the fixation plate portion 37.

A mounting seat portion 38 is formed in a portion of the bottom wall portion 30a on the vehicle exterior side so as to be protruded downward. As shown in FIGS. 6A, 6B and 6C, the mounting seat portion 38 includes a cylindrical portion 38 a and a bottom plate portion 38b. The cylindrical portion 38a is tapered downward. The bottom plate portion 38b is disposed at a lower end of the cylindrical portion 38a. A lightening hole 38x is formed in the cylindrical portion 38a. In this embodiment, two lightening holes 38x are respectively formed on the vehicle front side and the vehicle rear side. A through hole 38y is formed in the bottom plate portion 38b.

### <The Grip Member>

The grip member 40 shown in FIGS. 3 and 4B is made of a synthetic resin material. The grip member 40 may be made of a material having low rigidity such as thermoplastic styrenic elastomer (TPS) or a material having high rigidity such as filler-added polypropylene (PPF). In this embodiment, the grip member 40 is made of a material having low rigidity.

The grip member 40 includes a raised wall portion 41 and a flange portion 42. The raised wall portion 41 is opposed to the support wall portion 30b of the pull handle core material 30. The flange portion 42 is disposed at an upper end of the raised wall portion 41 so as to be protruded toward the vehicle interior side and toward the vehicle rear side. A surface of the raised wall portion 41 facing the vehicle exterior side is adapted to be held by the occupant with his/her fingers. A surface of the raised wall portion 41 facing the vehicle interior side is supported by the support wall portion 30b.

As shown in FIGS. 3 and 4B, three engagement plate portions 43 are disposed in a lower end portion of the raised wall portion 41. The engagement plate portions 43 are provided corresponding to the engagement holes 31 (FIG. 4C) of the pull handle core material 30. The engagement plate portions 43 are protruded downward and has a plate surface thereof oriented in the vehicle width direction. A claw portion 43a is disposed in a basal end portion of the engagement plate portion 43 on the vehicle interior side.

As shown in FIG. 4B, two engagement plate portions 44 are disposed in the surface of the raised wall portion 41 on the vehicle interior side. The engagement plate portions 44 are provided corresponding to the engagement holes 33 (FIGS. 3 and 4C) of the pull handle core material 30. The engagement plate portions 44 are protruded downward and has a plate surface thereof oriented in the vehicle width direction. A claw receiving hole 44a is formed in the engagement plate portion 44.

As shown in FIG. 3, two positioning holes 45 having rectangular configurations are formed in the flange portion 42. The positioning holes 45 are provided corresponding to the positioning protrusions 36 of the pull handle core material 30.

### <Coupling the Grip Member to the Pull Handle Core Material>

As shown in FIGS. 4A, 5A and 5B, the grip member 40 is coupled to the pull handle core material 30.

The grip member 40 is brought closer to the pull handle core material 30 from above on the vehicle exterior side, and the engagement plate portions 43 of the grip member 40 are inserted into the engagement holes 31 of the pull handle core material 30. At this time, as shown in FIGS. 4A and 5A, the claw portions 43a of the engagement plate portions 43 are engaged with the claw receiving plate portions 32 of the engagement holes 31.

At the same time, the engagement plate portions 44 are inserted into the engagement holes 33. At this time, as shown in FIGS. 4A and 5B, the claw portions 34 in the edge portions of the engagement holes 33 are engaged with the claw receiving holes 44a of the engagement plate portions 44. Thereby, the grip member 40 and the pull handle core material 30 are brought to a coupled state as shown in FIG. 4A. In this state, the positioning protrusions 36 of the pull handle core material 30 are fitted in the positioning holes 45 of the grip member 40, and thereby, the grip member 40 and the pull handle core material 30 are positioned.

In the pull handle 5 including the grip member 40 and the pull handle core material 30 coupled together, the raised wall portion 41 of the grip member 40 is raised from a portion of the edge portion of the bottom wall portion 30a of the pull handle core material 30 from the vehicle interior side to the vehicle rear side.

### <Coupling the Pull Handle to the Armrest Core Material>

As shown in FIG. 1B, the pull handle 5 having the features mentioned above is coupled to the armrest core material 20.

The boss portions 23, 23 of the armrest core material 20 are respectively fitted in the fitting holes 37a, 37a of the fixation plate portions 37, 37 of the pull handle core material 30. Distal end portions of the boss portions 23, 23 are respectively welded to peripheral edge portions of the fitting holes 37a, 37a.

### <Coupling the Pull Handle to the Door Panel>

As shown in FIG. 2, the pull handle 5 having the features mentioned above is coupled to the door panel 2 via a bracket 6.

The bracket 6 has a L-shaped configuration. The bracket 6 integrally includes a generally vertical panel side portion 6a and a generally horizontal vehicle interior side portion 6b. The panel side portion 6a is joined to the door panel 2 by a screw 7 and a screw grommet 7a. An under surface of the bottom plate portion 38b of the mounting seat portion 38 of the pull handle core material 30 is outfitted with the vehicle interior side portion 6b. A screw 8 passed through the through hole 38y of the bottom plate portion 38b is screwed into the vehicle interior side portion 6b. Thereby, the pull handle 5 is coupled to the bracket 6, and further to the door panel 2.

### <Weakening Structure of the Pull Handle>

The pull handle 5 has a structure to be easily squashed when the occupant is hit against the pull handle 5 having the features mentioned above in a second collision following a side collision and a load F shown in FIG. 1A in the vehicle width direction is applied to the pull handle 5.

As shown in FIGS. 5A, 5B, 6A, 6B and 6C, the bottom wall portion 30a of the pull handle core material 30 is slightly bent in the vehicle width direction. The bottom wall portion 30a is slightly inclined such that a vehicle interior side portion and a vehicle exterior side portion thereof are convex downward. As shown in FIG. 6A, a top surface of the bottom wall portion 30a has a rounded portion 39 formed in an intersecting portion of a vehicle interior side portion and a vehicle exterior side portion thereof. The rounded portion 39 extends in the vehicle length direction. The rounded portion 39 has a curved surface slightly curved toward the vehicle width direction. The rounded portion 39 may be formed in an under surface of the bottom wall portion 30a. The rounded portion 39 may be formed both in the top surface and the under surface of the bottom wall portion 30a. The rounded portion 39 can trigger the bottom wall portion 30a to be bent in the vehicle width direction at a time of side collision.

As shown in FIGS. 6A, 6B, and 6C, a thinned-out part 50 continuous from the mounting seat portion 38 to the edge portion of the bottom wall portion 30a is formed in the bottom wall portion 30a. The thinned-out part 50 is formed so as to shave the under surface of the bottom wall portion 30a. The thinned-out part 50 may include thinned-out portions 51, 55 extending along the vehicle length direction and thinned-out portions 52, 53, 54 extending along the vehicle width direction. The thinned-out part 50 may be formed so as to shave the top surface of the bottom wall portion 30a.

One end of the thinned-out portion 51 is continuous with the lightening hole 38x on a front side of the mounting seat portion 38. The thinned-out portion 51 extends from the one end thereof toward a vehicle front such that the thinned-out portion 51 is slightly inclined to the vehicle interior side toward the vehicle front. The thinned-out portion 51 extends up to just before a front most engagement hole 31 in the vehicle length direction and to a position beyond the rounded portion 39 in the vehicle width direction.

The other end of the thinned-out portion 51 is continuous with one end of the thinned-out portion 52. The thinned-out portion 52 extends from the one end thereof toward the vehicle interior side such that the thinned-out portion 52 is slightly inclined to the vehicle front toward the vehicle interior side. The other end of the thinned-out portion 52 is continuous with the front most engagement hole 31.

An intermediate portion of the thinned-out portion 51 is continuous with one end of the thinned-out portion 53. The thinned-out portion 53 extends from the one end thereof toward the vehicle interior side beyond the rounded portion 39. The other end of the thinned-out portion 53 is continuous with a second engagement hole 31 from the front.

One end of the thinned-out portion 54 is continuous with the cylindrical portion 38a of the mounting seat portion 38 on the vehicle interior side. The thinned-out portion 54 extends from the one end thereof toward the vehicle interior side beyond the rounded portion 39. The other end of the thinned-out portion 54 is continuous with a rear most engagement hole 31.

One end of the thinned-out portion 55 is continuous with the lightening hole 38x on a rear side of the mounting seat portion 38. The thinned-out portion 55 extends from the one end thereof toward a vehicle rear such that the thinned-out portion 55 is inclined to the vehicle interior side toward the vehicle rear. The thinned-out portion 55 extends beyond the rounded portion 39 in the vehicle width direction. The other end of the thinned-out portion 55 is continuous with a lower end of the lightening hole 35 formed in the intersecting portion between a rear side portion of the support wall portion 30b and the bottom wall portion 30a.

A thinned-out part 60 is formed in the rear side portion of the support wall portion 30b. The thinned-out part 60 is formed so as to shave a rear surface of the support wall portion 30b. The thinned-out part 60 may be formed so as to shave a front surface of the support wall portion 30b. The thinned-out part 60 extends upward from an upper end of the lightening hole 35 to an upper end of the support wall portion 30b.

### <Effects of The First Embodiment>

According to the pull handle 5 having the features mentioned above, the thinned-out part 50 formed in the bottom wall portion 30a can be bent at a time of side collision and trigger the bottom wall portion 30a to be squashed. The thinned-out part 60 formed in the support wall portion 30b can be bent at a time of side collision and trigger the support wall portion 30b to be squashed.

The bottom wall portion 30a is weakened by the thinned-out part 50's being continuous from the mounting seat portion 38 to the edge portion of the bottom wall portion 30a. The support wall portion 30b is weakened by the thinned-out part 60 and the lightening hole 35's being continuous from the upper end to a lower end of the support wall portion 30b.

Particularly, the bottom wall portion 30a is weakened by the thinned-out portions 51, 55's being continuous with the lightening hole 38x that is a weakened portion of the mounting seat portion 38, the thinned-out portions 52, 53, 54's being continuous with the engagement hole 31 that is a weakened portion of the bottom wall portion 30a and the thinned-out portion 55's being continuous with the lightening hole 35 that is a weakened portion of the intersecting portion between the bottom wall portion 30a and the support wall portion 30b.

The thinned-out portions 51, 55 of the thinned-out part 50 extending along the vehicle length direction can trigger the thinned-out part 50 to be bent in the vehicle width direction. The thinned-out portions 52, 53, 54 extending along the vehicle width direction can trigger the thinned-out part 50 to be bent in the vehicle length direction.

According to the embodiment mentioned above, impact absorbing capacity of the pull handle 5 can be enhanced.

Other embodiments of the present disclosure will be described hereinafter. In the description of the other embodiments, only features different from those of the embodiment mentioned above will be described. Features similar to those of the embodiment mentioned above will be denoted by same reference numerals and the explanation thereof will be omitted.

### Second Embodiment

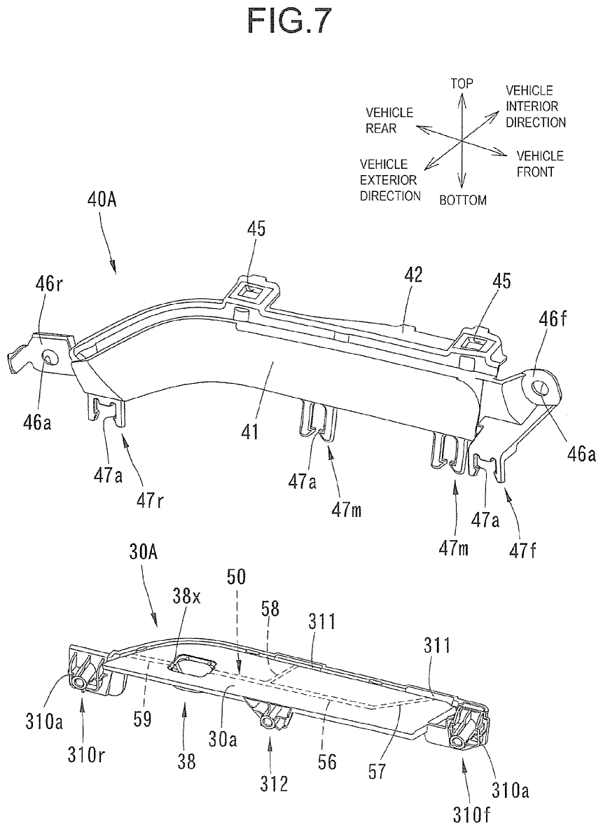

FIG. 7 shows a second embodiment of the present disclosure. In this embodiment, a pull handle core material includes a bottom wall portion, but not a support wall portion. A grip member is coupled to the pull handle core material in a different manner from the first embodiment.

A grip member 40A (second member) is made of a material having high rigidity such as filler-added polypropylene (PPF). The grip member 40A includes fixation plate portions 46f, 46r each having a fitting hole 46a formed therein in front of and to a rear of a raised wall portion 41. The fixation plate portions 46f, 46r are respectively used for coupling to a lower trim 3a and an armrest core material 20. A positioning hole 45 of a flange portion 42 is used for positioning with respect to the armrest core material 20.

A plurality of (four in this embodiment) engagement plate portions 47f, 47m, 47m, 47r protruded downward are disposed in a lower end of the grip member 40A. The engagement plate portions 47f, 47m, 47m, 47r are spacedly arranged in a vehicle length direction. The engagement plate portions 47m, 47m (insertion plates) are disposed in a lower end of the raised wall portion 41. The engagement plate portions 47f, 47m, 47m, 47r include claw portions 47a protruded inward at respective distal end portions of pairs of arm plate portions thereof.

A pull handle core material 30A (first member) has boss portions 310f, 310r having circular cylindrical configurations disposed in front of and to a rear of a bottom wall portion 30a. The boss portions 310f, 310r are provided corresponding to the engagement plate portions 47f, 47r on a front side and on a rear side. The boss portions 310f, 310r include claw receiving portions 310a respectively protruded in radial directions of the boss portions 310f, 310r. The claw receiving portion 310a has a plate surface thereof oriented in a vertical direction. Two insertion holes 311 are formed in an edge portion of the bottom wall portion 30a on a vehicle interior side corresponding to the two engagement plate portions 47m, 47m disposed at the lower end of the raised wall portion 41.

By bringing the grip member 40A closer to the pull handle core material 30A from above, the engagement plate portions 47f, 47r of the grip member 40A are respectively engaged with the claw receiving portions 310a, 310a of the boss portions 310f, 310r. The engagement plate portions 47m, 47m below the raised wall portion 41 are respectively inserted into the insertion holes 311, 311 and engaged with claw receiving portions that are not shown.

A boss portion 312 having a circular cylindrical configuration is disposed in an edge portion of the bottom wall portion 30a on a vehicle exterior side and in an intermediate portion of the bottom wall portion 30a in a vehicle length direction. The boss portion 312 is protruded toward the vehicle exterior side in a vehicle width direction. The boss portion 312 is used for coupling to a middle trim 3b.

A thinned-out part 50 is formed in the bottom wall portion 30a. The thinned-out part 50 includes thinned-out portions 56, 59 extending along the vehicle length direction and thinned-out portions 57, 58 extending along the vehicle width direction.

The thinned-out portion 56 extends from a lightening hole 38x on a front side of a mounting seat portion 38 toward a vehicle front. The thinned-out portion 57 extends from a front end of the thinned-out portion 56 toward the vehicle interior side and continues to the insertion hole 311 on a front side. The thinned-out portion 58 extends from an intermediate portion of the thinned-out portion 56 toward the vehicle interior side. The thinned-out portion 58 is continuous with the insertion hole 311 on a rear side.

The thinned-out portion 59 extends from the lightening hole 38x on a rear side of the mounting seat portion 38 to a rear end of the bottom wall portion 30a toward a rear of a vehicle.

The present disclosure is not limited to the embodiments mentioned above and various modifications may be made without departing from the gist of the disclosure.

In the embodiments mentioned above, the mounting seat portion 38 of the pull handle 5 is coupled to the door panel 2 via the bracket 6. Alternatively, the mounting seat portion 38 may be coupled to the door trim 3 via the bracket 6.

In the embodiments mentioned above, the bottom wall portion 30a is disposed in the pull handle core material 30, 30A (first member) and the raised wall portion 41 is disposed in the grip member 40, 40A (second member). Alternatively, the bottom wall portion and the raised wall portion may be disposed in a same member.

The present disclosure may be applied to a pull handle disposed on a door of a vehicle on a vehicle interior side thereof.

According to the present disclosure, impact absorbing capacity of a pull handle can be enhanced.

Although an example embodiment and modification examples of the disclosure are described hereinabove, the foregoing embodiment and modification examples are mere examples and are not intended to limit the scope of the disclosure. It should be also appreciated that various omissions, replacements, and modifications may be made in the foregoing embodiment and modification examples described herein, without departing from the scope of the disclosure. The disclosure is intended to include such modifications and alterations in so far as they fall within the scope of the appended claims or the equivalents thereof.

1. A pull handle for a door of a vehicle to be mounted on a door trim disposed in a door panel of the vehicle on a vehicle interior side, the pull handle comprising:
a bottom wall portion; and
a raised wall portion raised from at least an edge portion of the bottom wall portion on the vehicle interior side, wherein an occupant can put his/her fingers on the raised wall portion,
wherein a mounting seat portion for securing the pull handle to the door panel or the door trim is formed in the bottom wall portion such that the mounting seat portion is protruded downward, and
wherein a thinned-out part continuous from the mounting seat portion to the edge portion of the bottom wall portion is formed in the bottom wall portion.

2. The pull handle for the door of the vehicle according to claim 1, wherein the thinned-out part comprises a portion extending along a vehicle length direction and a portion extending along a vehicle width direction.

3. The pull handle for the door of the vehicle according to claim 1 or 2, wherein the pull handle comprises:
a first member having the bottom wall portion disposed therein, the bottom wall portion comprising the mounting seat portion and the thinned-out part, the bottom wall portion having an insertion hole formed in an edge portion thereof; and
a second member having the raised wall portion and an insertion plate disposed therein, the insertion plate protruded from the raised wall portion,
wherein the second member is mounted on the first member in a state in which the insertion plate is inserted in the insertion hole, and
wherein the thinned-out part of the bottom wall portion of the first member is continuous from the mounting seat portion to the insertion hole.

4. The pull handle for the door of the vehicle according to claim 1 or 2, wherein
the mounting seat portion comprises a bottom plate portion and a cylindrical portion having a lightening hole formed therein, and
wherein the thinned-out part is continuous with the lightening hole of the cylindrical portion.
